(19) United States
(12) Patent Application Publication
(10) Pub. No.: US 2021/0350488 A1
(43) Pub. Date: Nov. 11, 2021

(54) METHODS AND SYSTEMS FOR NOTIFYING USER OF CHANGE TO DATA SHARING SETTINGS

(71) Applicant: Shopify Inc., Ottawa (CA)

(72) Inventor: Zabrina HOSSAIN, Toronto (CA)

(21) Appl. No.: 16/870,306

(22) Filed: May 8, 2020

(51) Int. Cl. G06Q 50/26; G06Q 10/10; G06Q 30/06; G06F 16/23; G06F 21/62

(52) U.S. Cl. CPC G06Q 50/265; G06Q 10/10; G06F 21/6245; G06F 16/2379; G06F 21/6263; G06Q 30/0609

(57) ABSTRACT

Methods and systems for notifying a user of changes to an online store's data sharing settings are described. In response to a current event associated with the user at the online store, a first timestamp is determined. The first timestamp is associated with a previous event associated with the user at the online store. A change to the online store's data sharing settings is determined, where the change is associated with a second timestamp indicating a time between the first timestamp and the current event. A notification is transmitted to a device associated with the user indicating the change.

### FIELD

The present disclosure is related to methods and systems for notifying a user of changes to an online store's settings, including changes to data sharing settings associated with an online store.

### BACKGROUND

An online store may be legally required to accurately inform users about how user data is collected, stored and shared. Typically, information about the store's data sharing settings are communicated to a user in the form of a privacy policy. A privacy policy is a legal document that is often lengthy and full of legal jargon. It can be difficult for a user visiting an online store to fully understand a store's privacy policy. It is often time-consuming for a user to fully understand how the privacy policy or data sharing settings applies to their specific situation.

Accordingly, it would be useful to provide a way to more effectively inform a user of updates to an online store's data sharing settings.

### SUMMARY

In various examples, the present disclosure describes methods and systems to automatically notify a user of any changes to an online store's data sharing settings since the user's previous interaction with the online store.

In some examples, the user may be associated with a user profile that includes a set of predefined settings that are acceptable to the user. In such a case, if the change to the online store's data sharing settings is within the predefined settings in the user profile, the change may not be notified to the user. Further, the user profile may be automatically updated to reflect a user's acceptance of the online store's data sharing settings.

In various examples, the present disclosure also describes methods and system to automatically update an online store's privacy policy based on changes to the data sharing settings associated with the online store. The online store's data sharing settings may be changed by, for example, a merchant manually changing the store configuration settings and/or changes to applications (e.g., third-party apps or first-party apps) installed for the online store.

In some examples, the present disclosure describes a method. The method includes: in response to a current event associated with a user at an online store, determining a first timestamp associated with a previous event associated with the user at the online store; determining at least one change to a set of data sharing settings associated with the online store, the at least one change being associated with a second timestamp indicating a time between the first timestamp and the current event; and transmitting a notification to a device associated with the user indicating the at least one change.

In any of the examples, the at least one change may be one or more of: a change to type of user data collected, a change to how collected data is shared, a change to how long collected data is stored, a change to which service provider is sharing collected data, or a change to how a service provider is sharing collected data.

In any of the examples, the at least one change may be a result of: an installation of an application associated with the online store, an uninstallation of an application associated with the online store, a change in data sharing with an installed application associated with the online store, or a change in configuration settings associated with the online store.

In any of the examples, the method may further include: determining, from a stored privacy profile associated with the user, whether the at least one change is indicated as acceptable within a set of predefined settings in the privacy profile; and wherein the notification is transmitted after determining that the at least one change is excluded from the set of predefined settings.

In any of the examples, the method may further include: transmitting the notification, including a selectable option to accept the at least one change; and after receiving input indicating the at least one change is accepted, updating the privacy profile associated with the user to include the at least one change in the set of predefined settings.

In any of the examples, the privacy profile may be updated to include the at least one change in the set of predefined settings in association with the online store.

In any of the examples, the privacy profile may be updated to include the at least one change in the set of predefined settings in association with a plurality of online stores.

In any of the examples, the method may further include: in response to an update to a privacy policy associated with the online store, determining at least a second change to the set of data sharing settings associated with the online store; transmitting a second notification to the device associated with the user indicating at least the second change; and updating the first timestamp to reflect a time associated with the updated to the privacy policy.

In any of the examples, the notification may be transmitted when the at least one change is an increase in data collection or an increase in data sharing.

In any of the examples, the method may further include: transmitting the notification, including a selectable option to reject the at least one change; and blocking the current event or a further event at the online store after receiving input indicating the at least one change is rejected.

In some examples, the present disclosure describes a system including a processing device in communication with a storage. The processing device is configured to execute instructions to cause the system to perform any of the methods described herein.

In some examples, the present disclosure describes a computer readable medium having computer-executable instructions stored thereon. The instructions, when executed by a processing device of a system, cause the system to perform any of the methods described herein.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 shows an example data flow that may take place when a purchase is made using the e-commerce platform of FIG. 1;

FIG. 5 is a block diagram illustrating an example implementation of the e-commerce platform of FIG. 1;

FIG. 6 is another block diagram of the e-commerce platform of FIG. 1, showing some details related to privacy management;

FIGS. 7A and 7B illustrate example user interfaces that may be used to manage data sharing settings associated with an online store;

FIG. 8 is a flowchart illustrating an example method for notifying a user of changes to data sharing settings at an online store;

FIGS. 9A and 9B illustrate example notifications that may be transmitted to a user device to notify the user of changes to data sharing settings at an online store; and

FIG. 10 is a flowchart illustrating an example method for automatically updating a privacy policy associated with an online store.

Similar reference numerals may have been used in different figures to denote similar components.

### DESCRIPTION OF EXAMPLE EMBODIMENTS

The present disclosure will be described in the context of an e-commerce platform, discussed below. However, it should be understood that this discussion is only for the purpose of illustration and is not intended to be limiting. Further, it should be understood that the present disclosure may be implemented in other contexts, and is not necessarily limited to implementation in an e-commerce platform.

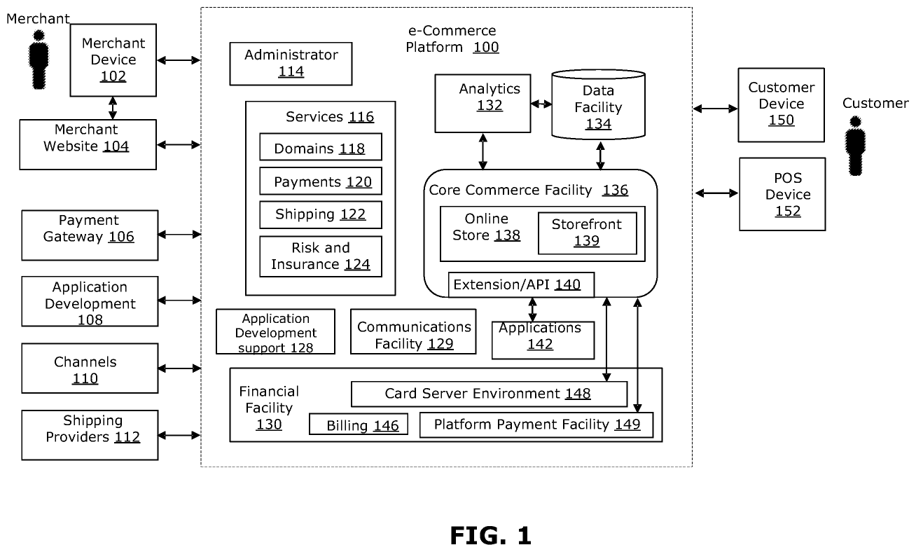

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products or offerings. All references to products or offerings throughout this disclosure should also be understood to be references to products and/or services, including physical products, digital content, tickets, subscriptions, services to be provided, and the like.

While the disclosure throughout contemplates that a “merchant”, a “user” and a “customer” may be more than individuals, for simplicity the description herein may generally refer to merchants, users and customers as such. All references to merchants, users and customers throughout this disclosure should also be understood to be references to groups of individuals, companies, corporations, computing entities, and the like, and may represent for-profit or not-for-profit exchange of products. Further, while the disclosure throughout refers to “merchants”, and “customers”, and describes their roles as such, it should be understood that merchants and customers may also be generally referred to as users of the e-commerce platform 100, and aspects of the e-commerce platform 100 may be more generally available to support users in an e-commerce environment. All references to merchants and customers throughout this disclosure should also be understood to be references to users, such as where a user is a merchant-user (e.g., a seller, retailer, wholesaler, or provider of products), or a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Further, it should be understood that any individual or group of individuals may play more than one role and may fit more than one label in the e-commerce environment. For example, a corporate user may also be a customer.

The e-commerce platform 100 may provide a centralized system for providing merchants with online resources for managing their business. Merchants may utilize the e-commerce platform 100 for managing commerce with customers, such as by implementing an e-commerce experience with customers through an online store 138, through channels 110, through point of sale (POS) devices 152 in physical locations (e.g., a physical storefront or other location such as through a kiosk, terminal, reader, printer, 3D printer, and the like), by managing their business through the e-commerce platform 100, by interacting with customers through a communications facility 129 of the e-commerce platform 100, or any combination thereof.

The online store 138 may represent a multitenant facility comprising a plurality of virtual storefronts 139. In various embodiments, merchants may manage one or more storefronts 139 in the online store 138, such as through a merchant device 102 (e.g., computer, laptop computer, mobile computing device, and the like), and offer products to customers through a number of different channels 110 (e.g., an online store 138; a physical storefront through a POS device 152; electronic marketplace, through an electronic buy button integrated into a website or social media channel such as on a social network, social media page, social media messaging system; and the like). A merchant may sell across channels 110 and then manage their sales through the e-commerce platform 100. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront 139 through the online store 138, and utilizing the communications facility 129 to leverage customer interactions and analytics 132 to improve the probability of sales, for example.

In various embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication, and the like, providing a system for reaching customers and facilitating merchant services for the real or virtual pathways available for reaching and interacting with customers.

In various embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application development 108, channels 110, shipping providers 112, customer devices 150, POS devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a thin client via a web browser, accessed through by POS devices, and the like). In various embodiments, elements of the e-commerce platform 100 may be implemented to operate on various platforms and operating systems, such as iOS, Android, over the internet, and the like.

In various embodiments, storefronts 139 may be served by the e-commerce platform 100 to customers (e.g., via customer devices 150), where customers can browse and purchase the various products available (e.g., add them to a cart, purchase immediately through a buy-button, and the like). Storefronts 139 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their storefront 139. Merchants may customize the look and feel of their website through a theme system, such as where merchants can select and change the look and feel of their storefront 139 by changing their theme while having the same underlying product and business data shown within the storefront's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a basic content management system for website content. Merchants may author blog posts or static pages and publish them to their storefront 139 and/or website 104, such as through blogs, articles, and the like, as well as configure navigation menus. Merchants may upload images (e.g., for products), video, content, data, and the like to the e-commerce platform 100, such as for storage by the system. In various embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110, including the online store 138, over the telephone, as well as through physical POS devices 152 as described herein. The e-commerce platform 100 may provide business support services 116, an administrator component 114, and the like associated with running an on-line business, such as providing a domain service 118 associated with their online store, payments services 120 for facilitating transactions with a customer, shipping services 122 for providing customer shipping options for purchased products, risk and insurance services 124 associated with product protection and liability, merchant billing services 146, and the like. Services 116 may be provided via the e-commerce platform 100 or in association with external facilities, such as through a payment gateway 106 for payment processing, shipping providers 112 for expediting the shipment of products, and the like.

In various embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

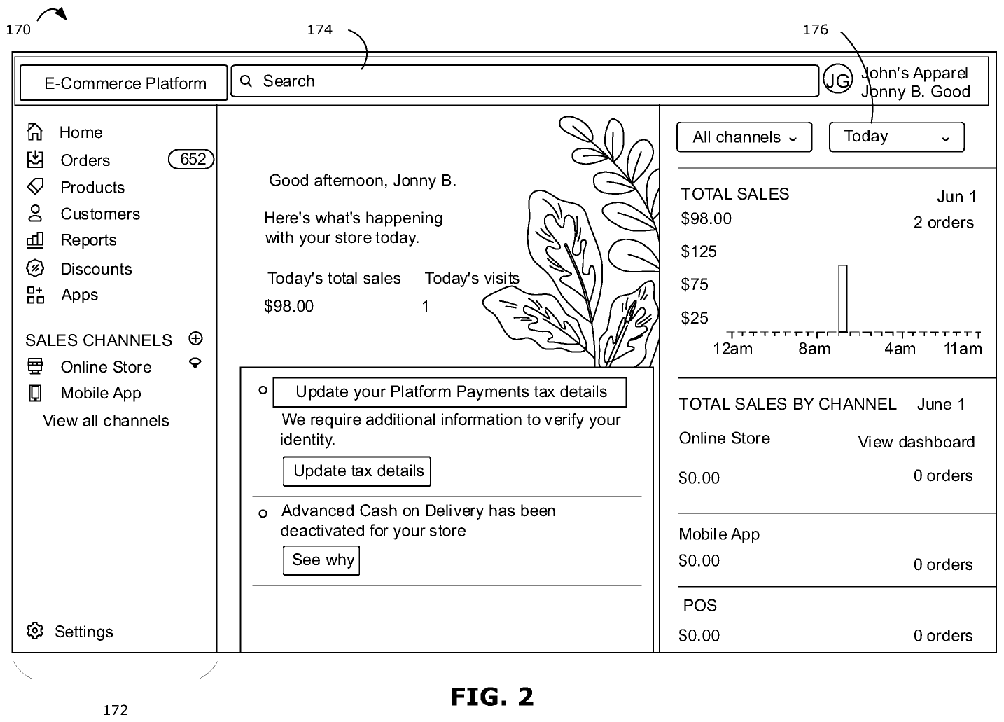

FIG. 2 depicts a non-limiting embodiment for a home page 170 of an administrator 114, which may show information about daily tasks, a store's recent activity, and the next steps a merchant can take to build their business. In various embodiments, a merchant may log in to administrator 114, such as from a browser or mobile device, and manage aspects of their storefront, such as viewing the storefront's recent activity, updating the storefront's catalog, managing orders, recent visits activity, total orders activity, and the like. In various embodiments, the merchant may be able to access the different sections of administrator 114 by using the sidebar 172, such as shown on FIG. 2. Sections of the administrator may include core aspects of a merchant's business, including orders, products, and customers; sales channels, including the online store, POS, and buy button; applications installed on the merchant's account; settings applied to a merchant's storefront 139 and account. A merchant may use a search bar 174 to find products, pages, or other information. Depending on the device the merchant is using, they may be enabled for different functionality through the administrator 114. For instance, if a merchant logs in to the administrator 114 from a browser, they may be able to manage all aspects of their storefront 139. If the merchant logs in from their mobile device, they may be able to view all or a subset of the aspects of their storefront 139, such as viewing the storefront's recent activity, updating the storefront's catalog, managing orders, and the like.

More detailed information about commerce and visitors to a merchant's storefront 139 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110 from different periods of time (e.g., days, weeks, months, and the like), such as by using drop-down menus 176. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's storefront 139, such as based on account status, growth, recent customer activity, and the like. Notifications may be provided to assist a merchant with navigating through a process, such as capturing a payment, marking an order as fulfilled, archiving an order that is complete, and the like.

Reference is made back to FIG. 1. The e-commerce platform may provide for a communications facility 129 and associated merchant interface for providing electronic communications and marketing, such as utilizing an electronic messaging aggregation facility (not shown) for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 130 for secure financial transactions with customers, such as through a secure card server environment 148. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 130 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

In various embodiments, the e-commerce platform 100 may be configured with a core commerce facility 136 for content management and task automation to enable support and services to the plurality of storefronts 139 (e.g., related to products, inventory, customers, orders, collaboration, suppliers, reports, financials, risk and fraud, and the like), but be extensible through applications 142 that enable greater flexibility and custom processes required for accommodating an ever-growing variety of merchant storefronts 139, POS devices 152, products, and services. For instance, the core commerce facility 136 may be configured for flexibility and scalability through portioning (e.g., sharding) of functions and data, such as by customer identifier, order identifier, storefront identifier, and the like. The core commerce facility 136 may accommodate store-specific business logic and a web administrator. The online store 138 may represent a channel, be embedded within the core commerce facility 136, provide a set of support and debug tools that support uses for merchants, and the like. The core commerce facility 136 may provide centralized management of critical data for storefronts 139.

The core commerce facility 136 includes base or “core” functions of the e-commerce platform 100, and as such, as described herein, not all functions supporting storefronts 139 may be appropriate for inclusion. For instance, functions for inclusion into the core commerce facility 136 may need to exceed a core functionality threshold through which it may be determined that the function is core to a commerce experience (e.g., common to a majority of storefront activity, such as across channels, administrator interfaces, merchant locations, industries, product types, and the like), is re-usable across storefronts (e.g., functions that can be re-used/modified across core functions), limited to the context of a single storefront at a time (e.g., implementing a storefront ‘isolation principle’, where code should not be able to interact with multiple storefronts at a time, ensuring that storefronts cannot access each other's data), provide a transactional workload, and the like. Maintaining control of what functions are implemented may enable the core commerce facility 136 to remain responsive, as many required features are either served directly by the core commerce facility 136 or enabled by its extension/application programming interface (API) 140 connection to applications 142. If care is not given to restricting functionality in the core commerce facility 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the core commerce facility 136 may be configured to maintain responsiveness, such as through configuration that utilizes timeouts, queues, back-pressure to prevent degradation, and the like.

Although isolating storefront data is important to maintaining data privacy between storefronts 139 and merchants, there may be reasons for collecting and using cross-store data, such as for example, with an order risk assessment system or a platform payment facility, both of which require information from a majority of storefronts 139 to perform well. In various embodiments, rather than violating the isolation principle, it may be preferred to move these components out of the core commerce facility 136 and into their own infrastructure within the e-commerce platform 100. For example, the data facility 134 and analytics 132 may be located outside the core commerce facility 136.

In various embodiments, the e-commerce platform 100 may provide for a platform payment facility 149, which is another example of a component that utilizes data from the core commerce facility 138 but may be located outside so as to not violate the isolation principle. The platform payment facility 149 may allow customers interacting with storefronts 139 to have their payment information stored safely by the core commerce facility 136 such that they only have to enter it once. When a customer visits a different storefront 139, even if they've never been there before, the platform payment facility 149 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from a storefront's checkout, allowing information to be made available globally across storefronts 139. It would be difficult and error prone for each storefront 139 to be able to connect to any other storefront 139 to directly retrieve the payment information stored there. As a result, the platform payment facility 149 may be implemented external to the core commerce facility 136.

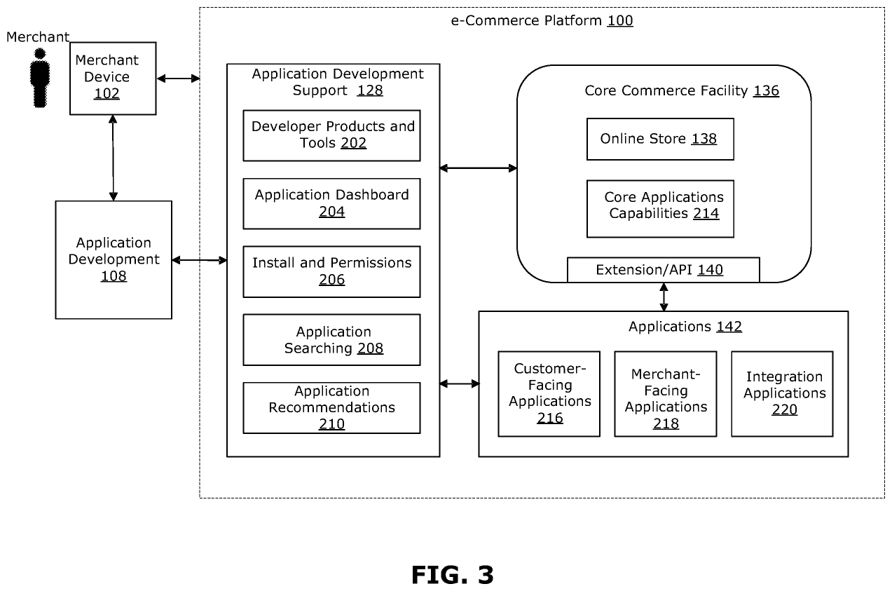

For those functions that are not included within the core commerce facility 138, applications 142 provide a way to add features to the e-commerce platform 100. Applications 142 may be able to access and modify data on a merchant's storefront 139, perform tasks through the administrator 114, create new flows for a merchant through a user interface (e.g., that is surfaced through extensions/API 140), and the like. Merchants may be enabled to discover and install applications 142 through application searching 208 and application recommendations 210 (see FIG. 3). In various embodiments, core products, core extension points, applications, and the administrator 114 may be developed to work together. For instance, application extension points may be built inside the administrator 114 so that core features may be extended by way of applications 142, which may deliver functionality to a merchant through the extension/API 140.

In various embodiments, applications 142 may deliver functionality to a merchant through the extension/API 140, such as where an application 142 is able to surface transaction data to a merchant (e.g., App: “Surface my app in mobile and web admin using the embedded app SDK”), and/or where the core commerce facility 136 is able to ask the application to perform work on demand (core: “App, give me a local tax calculation for this checkout”).

Applications 142 may support storefronts 139 and channels 110, provide merchant support, integrate with other services, and the like. Where the core commerce facility 136 may provide the foundation of services to the storefront 139, the applications 142 may provide a way for merchants to satisfy specific and sometimes unique needs. Different merchants will have different needs, and so may benefit from different applications 142. Applications 142 may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142 may be connected to the core commerce facility 136 through an extension/API layer 140, such as utilizing APIs to expose the functionality and data available through and within the core commerce facility 136 to the functionality of applications (e.g., through REST, GraphQL, and the like). For instance, the e-commerce platform 100 may provide API interfaces to merchant and partner-facing products and services, such as including application extensions, process flow services, developer-facing resources, and the like. With customers more frequently using mobile devices for shopping, applications 142 related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the core commerce facility 136, thus providing merchants what they need when they need it. For instance, shipping services 122 may be integrated with the core commerce facility 136 through a shipping or carrier service API, thus enabling the e-commerce platform 100 to provide shipping service functionality without directly impacting code running in the core commerce facility 136.

Many merchant problems may be solved by letting partners improve and extend merchant workflows through application development, such as problems associated with back-office operations (merchant-facing applications) and in the storefront (customer-facing applications). As a part of doing business, many merchants will use mobile and web related applications on a daily basis for back-office tasks (e.g., merchandising, inventory, discounts, fulfillment, and the like) and storefront tasks (e.g., applications related to their online shop, for flash-sales, new product offerings, and the like), where applications 142, through extension/API 140, help make products easy to view and purchase in a fast growing marketplace. In various embodiments, partners, application developers, internal applications facilities, and the like, may be provided with a software development kit (SDK), such as through creating a frame within the administrator 114 that sandboxes an application interface. In various embodiments, the administrator 114 may not have control over nor be aware of what happens within the frame. The SDK may be used in conjunction with a user interface kit to produce interfaces that mimic the look and feel of the e-commerce platform 100, such as acting as an extension of the core commerce facility 136.

Applications 142 that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the core commerce facility 136, such as for synchronizing a local database, notifying an external integration partner, and the like. Update events may enable this functionality without having to poll the core commerce facility 136 all the time to check for updates, such as through an update event subscription. In various embodiments, when a change related to an update event subscription occurs, the core commerce facility 136 may post a request, such as to a predefined callback URL. The body of this request may contain a new state of the object and a description of the action or event. Update event subscriptions may be created manually, in the administrator facility 114, or automatically (e.g., via the API). In various embodiments, update events may be queued and processed asynchronously from a state change that triggered them, which may produce an update event notification that is not distributed in real-time.

Reference is made to FIG. 3, which is another depiction of the e-commerce platform 100. FIG. 3 omits some details that have been described with reference to FIG. 1, and shows further details discussed below. In various embodiments, the e-commerce platform 100 may provide application development support 128. Application development support 128 may include developer products and tools 202 to aid in the development of applications, an application dashboard 204 (e.g., to provide developers with a development interface, to administrators for management of applications, to merchants for customization of applications, and the like), facilities for installing and providing permissions 206 with respect to providing access to an application 142 (e.g., for public access, such as where criteria must be met before being installed, or for private use by a merchant), application searching 208 to make it easy for a merchant to search for applications 142 that satisfy a need for their storefront 139, application recommendations 210 to provide merchants with suggestions on how they can improve the user experience through their storefront 139, a description of core application capabilities 214 within the core commerce facility 136, and the like. These support facilities may be utilized by application development 108 performed by any entity, including the merchant developing their own application 142, a third-party developer developing an application 142 (e.g., contracted by a merchant, developed on their own to offer to the public, contracted for use in association with the e-commerce platform 100, and the like), or an application being developed by internal personal resources associated with the e-commerce platform 100. In various embodiments, applications 142 may be assigned an application identifier (ID), such as for linking to an application (e.g., through an API), searching for an application, making application recommendations, and the like.

The core commerce facility 136 may include base functions of the e-commerce platform 100 and expose these functions through APIs to applications 142. The APIs may enable different types of applications built through application development 108. Applications 142 may be capable of satisfying a great variety of needs for merchants but may be grouped roughly into three categories: customer-facing applications 216, merchant-facing applications 218, or integration applications 220. Customer-facing applications 216 may include storefront 139 or channels 110 that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 218 may include applications that allow the merchant to administer their storefront 139 (e.g., through applications related to the web or website or to mobile devices), run their business (e.g., through applications related to POS devices 152), to grow their business (e.g., through applications related to shipping (e.g., drop shipping), use of automated agents, use of process flow development and improvements), and the like. Integration applications 220 may include applications that provide useful integrations that participate in the running of a business, such as shipping providers 112 and payment gateways.

In various embodiments, an application developer may use an application proxy to fetch data from an outside location and display it on the page of an online storefront 139. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142 so that the core commerce facility 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110, adds what they intend to buy to their cart, proceeds to checkout, and pays for the content of their cart resulting in the creation of an order for the merchant. The merchant may then view and fulfill (or cancel) the order. The product is then delivered to the customer. If the customer is not satisfied, they might return the products to the merchant.

In an example embodiment, a customer may browse a merchant's products on a channel 110. A channel 110 is a place where customers can view and buy products. In various embodiments, channels 110 may be modeled as applications 142 (a possible exception being the online store 138, which is integrated within the core commence facility 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In various embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., “secret” strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110 may use the core commerce facility 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through the card server environment 148. In various embodiments, the payment gateway 106 may accept international payment, such as integrating with leading international credit card processors. The card server environment 148 may include a card server application, card sink, hosted fields, and the like. This environment may act as the secure gatekeeper of the sensitive credit card information.

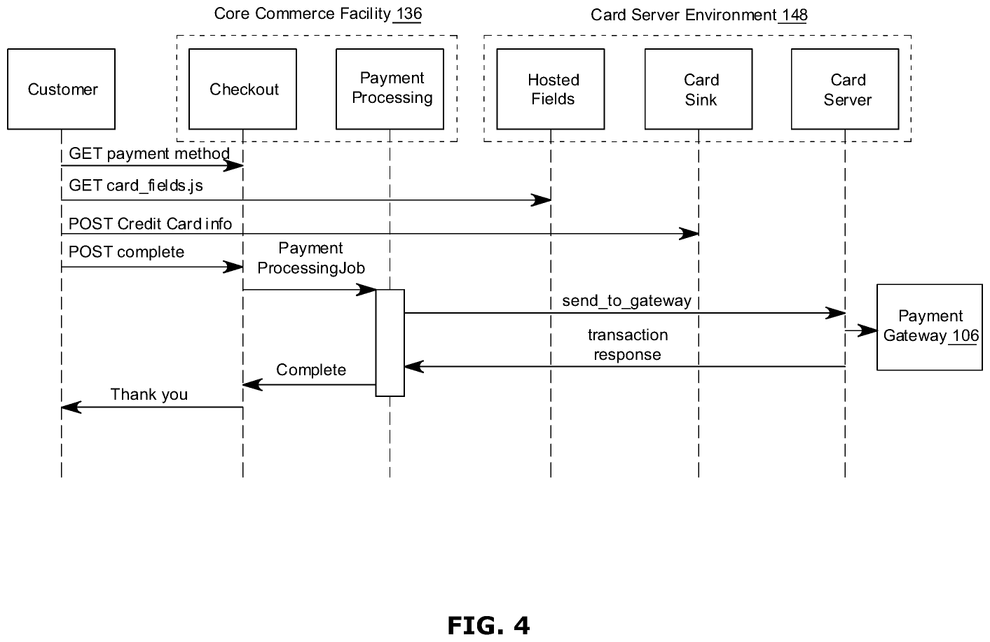

FIG. 4 presents, in a non-limiting example, a simplified sequence diagram of the interactions between the core commerce facility 136 and the card server environment 148 during payment processing of a credit, prepaid, gift or other card on a Web Checkout.

In various embodiments, most of the process may be orchestrated by a payment processing job. The core commerce facility 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110 that do not rely on core commerce facility checkouts may use an order API to create orders. Once an order is created, an order confirmation notification may be sent to the customer and an order placed notification sent to the merchant via a notifications component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as tailored towards impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor). The merchant may then view and fulfill (or cancel) the order.

An order assessment component may implement a business process merchants use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In various embodiments, this business process may be implemented by a fulfillment component. The fulfillment component may group the line items of the order into a logical fulfillment unit of work based on an inventory location and fulfillment service. The merchant may assess the order, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the core commerce facility 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a returns component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that were not returned and remain in the customer's hands); and the like. A return may represent a change to the contract of sale (e.g., the order), and where the e-commerce platform 100 may make the merchant aware of compliance issues with respect to legal obligations (e.g., with respect to taxes). In various embodiments, the e-commerce platform 100 may enable merchants to keep track of changes to the contract of sales over time, such as implemented through a sales model component (e.g., an append-only date-based ledger that records sale-related events that happened to an item).

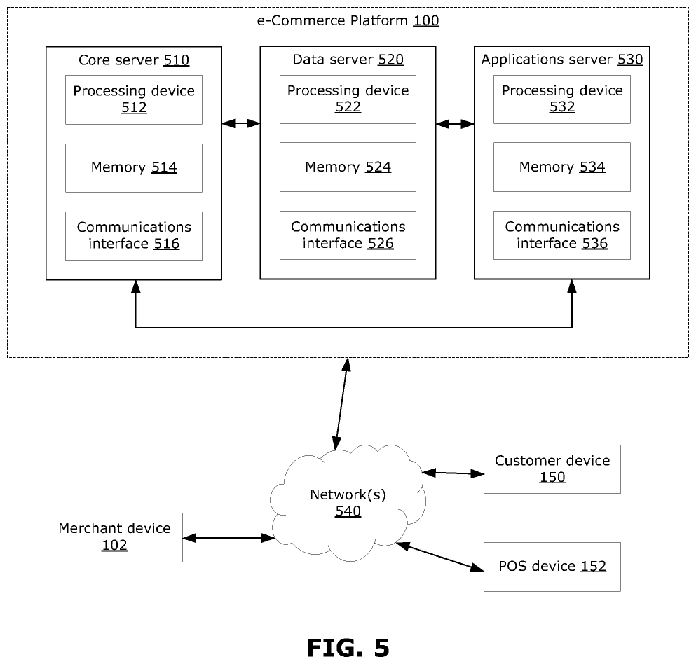

FIG. 5 is a block diagram of an example hardware configuration of the e-commerce platform 100. It should be noted that different components of the e-commerce platform 100 (e.g., the data facility 134, analytics facility 132, core commerce facility 136 and applications 142) may be implemented in separate hardware or software components, on a common hardware component or server or configured as a common (integrated) service or engine in the e-commerce platform 100. In the example of FIG. 5, the e-commerce platform 100 includes a core server 510, a data server 520 and an applications server 530, which are each in communication with each other (e.g., via wired connections and/or via wireless intranet connections). Each of the servers 510, 520, 530 include a respective processing device 512, 522, 532 (each of which may be, for example, a microprocessor, graphical processing unit, digital signal processor or other computational element), a respective memory 514, 524, 534 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 516, 526, 536 (each of which may include transmitter, receiver and/or transceiver for wired and/or wireless communications). The core server 510 may store instructions and perform operations relevant to core capabilities of the e-commerce platform, such as providing the administrator 114, analytics 132, core commerce facility 136, services 116 and/or financial facility 130, among others. The data server 520 may be used to implement the data facility 134, among others. The applications server 530 may store instructions and perform operations relevant to the applications 142, such as storing instructions and data for the applications 142 and for implementing application development support 128.

Merchants and customers, using respective devices 102, 150, 152 may access the e-commerce platform 100 via one or more networks 540 (e.g., wired and/or wireless networks, including a virtual private network (VPN), the Internet, and the like).

Although FIG. 5 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 514, 524, 534 may be replaced with external storage or cloud-based storage, among other possible modifications.

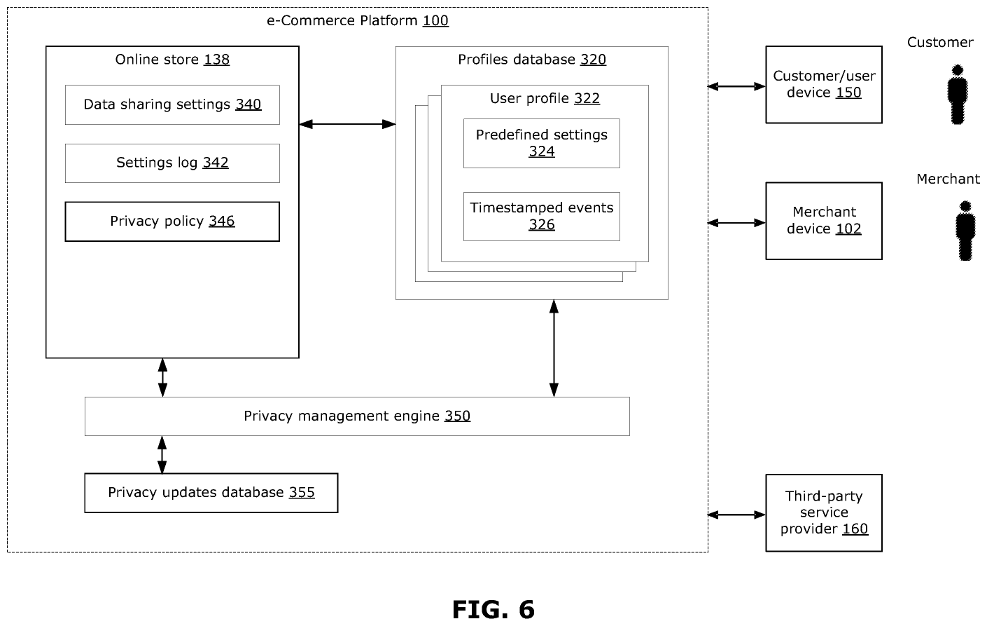

FIG. 6 is another depiction of the e-commerce platform 100 that omits some details that have been described with reference to FIG. 1, and shows further details discussed below. In particular, FIG. 6 illustrates some details of the e-commerce platform 100 that are relevant to privacy management. In the present disclosure, privacy management may include operations related to: management of settings, associated with an online store, that are related to collection and sharing of user data; management of a privacy policy, associated with an online store, that provides information about the data sharing settings; management of settings, associated with a user, that are related to consent for collection and sharing of the user's data; notification to a user of data collection and sharing; among other such operations.

In the context of privacy management, user data may be collected from any user who interacts with (e.g., visits a web site of) the online store 138. Such a user may or may not be a customer of the online store 138, and may or may not have an established relationship with the online store 138. The user's interaction with the online store 138 may be minor (e.g., viewing a single product page) or more extensive (e.g., completing an online purchase). In some cases, a user from whom user data may be collected may be referred to as a “visitor”, a “buyer”, a “customer”, or a “prospective customer”. For generality, the present disclosure will use the term “user” to refer to any customer or non-customer from whom user data may be collected by the online store 138.

From the viewpoint of the online store 138, user data may be collected during different events at the online store 138. Any data that is generated by events associated with the user at the online store 138 may be considered user data, regardless of whether that user data is considered to be sensitive data or less sensitive (or publicly available) data. An event that is associated with a user may include events representing explicit user input, such as a page view event, a checkout event, a transaction event, or a product search event, among other possibilities. An event that is associated with a user may also include events representing machine-based communications (e.g., HTTP communications) that might not be evident to the user such as requests/responses between the user device 102 and the e-commerce platform 100, or sessions-based communications.

A session (also referred to as a “web session” or “browser session”) comprises a set of request/response interactions between a user application (e.g., a client web browser at the user device 150) and a web application or service (e.g., the on-line store 138). A session is typically conducted for a relatively short and finite time duration (e.g., typically on the order of minutes to hours). A user identifier (e.g., a cookie) is assigned to a user during an established session, to enable servers to uniquely identify the user and to store user-specific data during the session. The user identifier may be stored (e.g., at the user device 150 and/or at a server managing the online store 138) to enable the user to be identified again and for stored user-specific data to be retrieved at a next session (e.g., the next time the user application engages with the web service).

Some example aspects of the online store 138, as illustrated in FIG. 6, are now discussed. For simplicity, only one online store 138 is illustrated. However, it should be understood that there may be a plurality of online stores 138 on the e-commerce platform 100. The online store 138 is associated with a set of one or more data sharing settings 340. Data sharing settings 340, in the present disclosure, may include settings related to collection of user data during events associated with the user at the online store 138. The data sharing settings 340 may also include settings related to how collected user data is stored and/or shared with a third-party provider 160 (or within the e-commerce platform 100). Data sharing settings 340 may also be referred to as privacy settings, because the user data being collected may include information considered to be private (e.g., information about the user's identity, the user's purchasing history, the user's online browsing history, etc.).

Each data sharing setting 340 may define the type of user data collected, how user data is stored and/or how user data is shared. Different, separate data sharing settings 340 may be used to define collection of different types of user data, to define sharing of user data with different service providers, and/or to define storing of user data within the e-commerce platform 100. By having separate data sharing settings 340 for different aspects of user data collection and sharing, the collection and sharing of user data may be managed in a more granular way. For example, a first service provider may be more trustworthy and a first data sharing setting 340 at the online store 138 may enable sharing of all user data with the first service provider; on the other hand, a second service provider may be less trustworthy and a second data sharing setting 340 may permit sharing of only a small fraction of user data with the second service provider. The set of data sharing settings 340 may include a mandatory data sharing setting, which must be complied with in order for a user to interact with the online store 138 (e.g., collection and/or sharing of user data that is required for proper operation of the online store 138 on the e-commerce platform 100, such as collection of user name and address to enable shipping of purchased products). The set of data sharing settings 340 may also include an optional data sharing setting, which does not require compliance but which may be desirable or preferred by the merchant managing the online store 138 (e.g., an optional data sharing setting may not be necessary for completing an online purchase but would enable the online store 138 to better target advertising towards the user).

The online store 138 is associated with a settings log 342 which includes information for tracking how store configuration settings, including data sharing settings 340, have been added or otherwise changed for the online store 138. A settings change may be logged as an entry in the settings log 342, for example using a code, index or other reference to identify the change that was made. Each settings change that is logged in the settings log 342 may also be associated with an indication (e.g., a timestamp) of the time (e.g., at least a date) when that change was made.

The online store 138 is also associated with a privacy policy 346, which is a representation of all the data sharing settings 340 for the online store 138. The privacy policy 346 may be a textual representation (e.g., a legal document), an infographic (e.g., a table), other visual or non-visual representation, and combinations thereof. The privacy policy 346, or portion thereof, may be presented to a user in response to an event at the online store 138, as discussed further below.

In some examples, a merchant may manage settings (including data sharing settings 340) associated with the online store 138 via a user interface (UI) provided by the e-commerce platform 100. For example, the merchant may access the administrator 114 (see FIG. 1) of the e-commerce platform 100 via the merchant device 102, and manage settings associated with the online store 138 using a UI accessible via a link on the home page 170 (see FIG. 2).

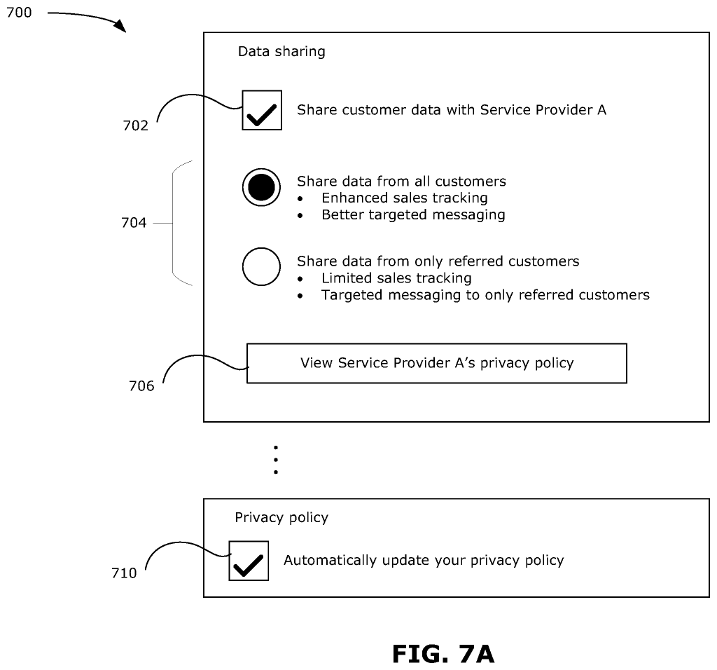

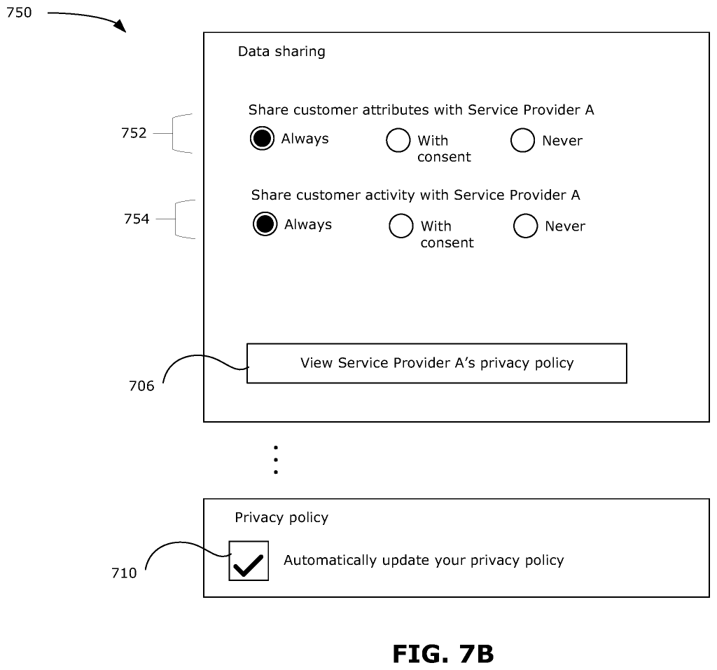

FIG. 7A illustrates an example UI 700 that may be used to manage data sharing settings 340 associated with the online store 138. The UI 700 may be generated by the e-commerce platform 100 to be presented on a merchant device 102, for example.

The example UI 700 shows, in particular, enables management of a data sharing setting 340 for a specific third-party service provider “Service Provider A”. The UI 700 provides an option 702 to enable or disable sharing of user data with Service Provider A. For example, Service Provider A may provide services to the online store 138 (e.g., tracking sales) that require the sharing of user data. Selection of the option 702 to enable sharing of user data with Service Provider A may cause further options 704 to be displayed in the UI 700. The options 704 may be selected to cause a selected level of data sharing with the Service Provider A. Information may be provided in the UI 700 to indicate the type and/or amount of user data shared for each level of data sharing, and/or the services provided by the service provide for each level of data sharing. In the example shown, a higher level of data sharing has been selected (in this case, using a radio button). The UI 700 may also provide a link 706 to provide a view of the service provider's privacy policy. Optionally, the UI 700 may also provide an option 710 to enable the online store's privacy policy 346 to be automatically updated based on the selected options for data sharing with the service provider. Examples for automatic updating of the online store's privacy policy 346 will be discussed further below.

FIG. 7B illustrates another example UI 750 that may be used to manage data sharing settings 340 associated with the online store 138. The UI 750 is similar to the UI 700 of FIG. 7A. However, instead of selectable options 702 and 704, the UI 750 provides options 752 and 754. The options 752, 754 can be selected to control sharing of user data with Service Provider A, for different types of user data (e.g., data related to customer attributes such as geographic location, contact information, etc.; or data related to customer activity such as page views, purchase history, etc.) and/or for different levels of data sharing (e.g., never share, only share with explicit user consent, or always share).

In some examples, after the data sharing settings 340 have been changed (e.g., using a UI provided by the e-commerce platform 100, or by a change to installed apps as discussed further below), the privacy management engine 350 may automatically generate a notification about how the data sharing settings 340 have been changed. For example, the notification may include information about how the changed data sharing settings 340 results in a change to the type of user data collected, a change to how long user data is stored, a change to how user data is shared, or a change to the third parties sharing the user data (e.g., a change the third party apps installed for the online store 138 and/or a change to how previous-installed third party apps are using user data). The notification may be displayed to a merchant managing the online store 138 (e.g., displayed via the merchant device 102) to enable the merchant to clearly understand how a manually changed setting or an installed application (e.g., third-party app or first-party app, where a first-party app may be an application that is provided by the e-commerce platform 100) affects collection and/or sharing of user data on the online store 138. The notification may also be automatically communicated (e.g., pushed) to users who have an existing relationship with the online store 138 (e.g., users who have subscribed to push communications from the online store 138). Such a push notification may inform the user of change to the data sharing settings 340 at the online store 138 without the user having an event (e.g., a visit) at the online store 138.

Reference is made to FIG. 6 again. The e-commerce platform 100 in this example includes a profiles database 320 containing stored user profiles 322. A user profile 322 may be associated with each unique user registered on the e-commerce platform 100. A user profile 322 may contain information (e.g., a unique identifier) to uniquely identify the user within the e-commerce platform 100, personal information (e.g., sensitive information such as home address, full legal name, income, etc.), information about events associated with the user (e.g., purchase event, page view event, product review event, product search event, etc.). In some examples, a user profile 322 may be created when a user initiates a purchase for the first time on the e-commerce platform 100, or when a user logs into the e-commerce platform 100 for the first time. A user may access the e-commerce platform 100 via the user device 150, to update information in the user profile 322 (e.g., via a user portal, user app or other UI provided by the e-commerce platform 100).

The user profile 322 associated with a user includes information indicating a set of predefined settings 324. The indicated predefined settings 324 include indication of data sharing settings that the user finds to be acceptable. The predefined settings 324 may specify the type of user data that the user consents to sharing. For example, a user may find it acceptable for an online store 138 to collect and share data about the user's purchase history. A predefined setting 324 may indicate an acceptable data sharing setting for a specific online store 138 (e.g., if a user is a frequent customer of that online store) and/or for a specific third-party service provider 160 (e.g., if a user finds that service provider to be trustworthy). Another predefined setting 324 may indicate an acceptable data sharing setting across all online stores 138 and/or across all third-party service providers 160. In some examples, the predefined settings 324 may similarly include indication of data sharing settings that the user does not find to be acceptable. For example, the e-commerce platform 100 may provide a user dashboard or a user portal (e.g., accessible via the user device 150) that enables the user to manage the predefined settings 324.

The user profile 322 also includes information about certain timestamped events 326 associated with the user at an online store 138, and the timestamp of those events. Timestamped events 326 may enable tracking of user activity on the e-commerce platform 100 across multiple online stores 138. In particular, the timestamped events 326 include events associated with user consent for data sharing at an online store 138 and the timestamp when consent was given. A timestamped event 326 may include any user input event or machine communication event, as discussed previously, at which the user may be presented with and/or asked to provide consent to a privacy policy 346 associated with an online store 138. In some examples, data (e.g., cookie) used for identifying a user in a session may be stored in the user profile 322.

It should be noted that not all events at an online store 138 are necessarily associated with a user who has a user profile 322 on the e-commerce platform 100. For example, a user who is not registered on the e-commerce platform 100 may nonetheless interact with (e.g., visit, view a product page, make a transaction on, etc.) the online store 138. For a user who is not associated with a user profile 322, there may not be any predefined settings 324 associated with the user, however the time of store events associated with that user may be tracked and stored using other techniques, such as the use of cookies or other identifying data (e.g., browser fingerprinting, etc.).

Generally, in the present disclosure, reference to a “user” may be understood to mean a user as identified via a verified user login (e.g., if the user is registered on the e-commerce platform 100), via identification data from the user device 150 (e.g., device identifier), via identification data generated by the user's online activity (e.g., browser fingerprinting, or cookie), or via self-identification by the user (e.g., the user sets up an account on the online store 138).

The e-commerce platform 100 in this example includes a privacy management engine 350. The privacy management engine 350 may be part of the core commerce facility 136, applications 142 or services 116 of the e-commerce platform 100 for example, or may be a standalone component of the e-commerce platform 100. The privacy management engine 350 may, for example, be implemented by the applications server 530 of FIG. 5. Furthermore, the e-commerce platform 100 could include multiple engines that implement the functionality provided by the privacy management engine 350. The multiple engines could be implemented in the same way, in similar ways and/or in distinct ways. In addition, at least a portion of the engine 350 could be implemented in the merchant device 102 and/or in the customer device 150. For example, the customer device 150 could store and run a privacy management engine 350 locally as a software application.

Although the engine 350 is illustrated as a distinct component of the e-commerce platform 100, this is only an example. The engine 350 could also or instead be provided by another component residing externally to the e-commerce platform 100 by third party service provider 160 for example. Although the embodiments are described below in association with an e-commerce platform, such as (but not limited to) the e-commerce platform 100, the embodiments described are not limited to e-commerce platforms.

In the example of FIG. 6, the privacy management engine 350 may access information from a privacy updates database 355. As will be discussed further below, the privacy updates database 355 contains data (which may be provided by the third-party service provider 160 and/or may be provided internally by a first-party service provider—namely the e-commerce platform 100) to enable updating of the privacy policy 346 associated with an online store 138. In some examples, the privacy management engine 350 may access another database external to the e-commerce platform 100 in addition to or instead of the privacy updates database 355, to retrieve data for updating the privacy policy 346.

The privacy management engine 350 may also access information associated with online stores 138 and associated with the user profiles 322 in the profiles database 320. For example, the privacy management engine 350 may access the settings log 342 and data sharing settings 340 associated with the online store 138 to compare with the predefined settings 324 and timestamped events 326 stored in a user profile 322 associated with a user, to determine whether and/or which portion of the privacy policy associated with the online store 138 should be notified to the user. Further details of how a user may be notified of a store's data sharing settings will be discussed below.

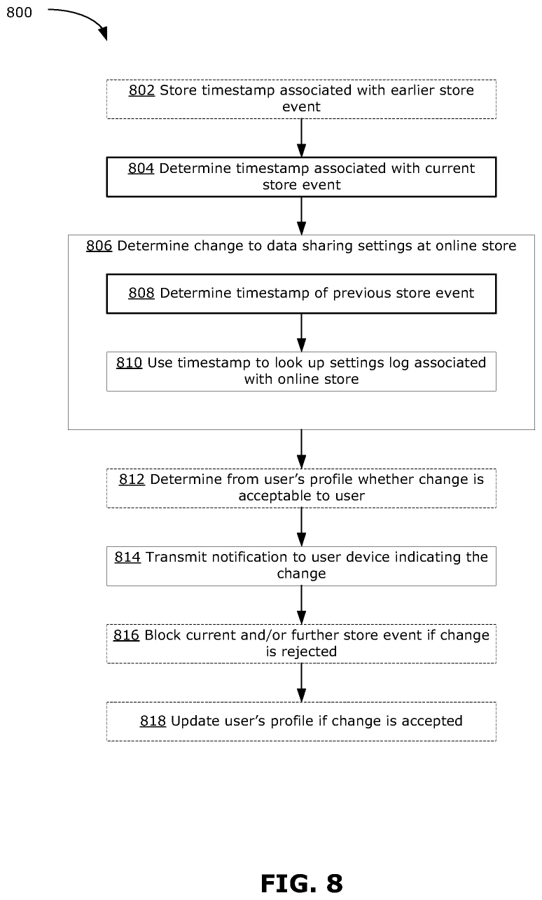

FIG. 8 is a flowchart illustrating an example method 800 for notifying a user of one or more changes to the data sharing settings associated with an online store. The method 800 may be implemented by the e-commerce platform 100 (e.g., using the privacy management engine 350). The method 800 may be implemented by a processing device executing instructions (e.g., at the core server 510 or the applications server 530).

Optionally, at 802, a timestamp is determined for an earlier store event and the timestamp is stored. The earlier store event is an event associated with a notification of an earlier version of the store's data sharing settings. The timestamp may be stored only if the user indicated that the earlier version of the store's data sharing settings is acceptable. If the user did not accept the earlier version of the online store's data sharing settings, the timestamp may not be stored.

For example, the earlier store event may be an earlier event representing user input (such as a page view event, a checkout event, a transaction event, or a product search event, among other possibilities) and/or an event representing machine-based communications (such as HTTP requests/responses, or sessions-based communications).

In some examples the earlier store event may be a notification that is pushed to the user (e.g., via an email communication) to notify the user of an earlier change to the stores data sharing settings.

In some examples, the earlier store event and associated timestamp may be stored as a timestamped event 326 in the user profile 322 associated with a user device and/or tracked using a cookie that is assigned to the user device (or user account if the user is logged in).

At 804, a timestamp is determined for a current event at the online store and associated with the user device. The current store event may be a current event representing user input (such as a page view event, a checkout event, a transaction event, or a product search event, among other possibilities) and/or an event representing machine-based communications (such as HTTP requests/responses, or sessions-based communications). In some examples, a timestamp is determined only for the earliest event at the online store during a user session. In other words, if the user interacts with the online store at multiple events during the same user sessions, the method 800 may be carried out only at the first interaction. This may avoid unnecessary use of processing resources, since it may be generally expected that the same set of data sharing settings would apply throughout a single user session.

At 806, at least one change to the data sharing settings of the online store is determined. The step 806 may be performed using steps 808 and 810.

At 808, a timestamp associated with an earlier event at the online store is determined. For example, the timestamp stored at optional step 802 may be determined (e.g., using information about timestamped events 326 in the user profile 322 associated with the user, and/or using a cookie assigned to the user).

At 810, the timestamp associated with the earlier event is used to look up the settings log 342 associated with the online store 138, in order to identify any changes to the data sharing settings 340 associated with the online store 138 since the earlier event. For example, the privacy management engine 350 may use the timestamp of the earlier event to identify any entries in the settings log 342 that are associated with timestamps later than the timestamp of the earlier event. Entries having timestamps later than the timestamp of the earlier event indicate changes to the data sharing settings 340 since the earlier event.

In some examples, it may not be necessary to explicitly determine the timestamp for the current event at step 804. Instead, it may be assumed that any entries in the settings log 342 associated with timestamps later than the timestamp of the earlier event indicate changes that took place between the earlier event and the current event. The timestamp for the current event may only need to be determined (and recorded) if the changes are accepted by the user (e.g., in response to the notification transmitted at step 814).

The data sharing settings 340 associated with the online store 138 may be changed by a merchant via the administrator 114 (e.g., using UIs as illustrated in FIGS. 7A and 7B), for example. The data sharing settings 340 may also be changed due to a change in collection and usage of user data by service providers (e.g., third-party service providers or first-party service provider) that provide services to the online store 138. The data sharing settings 340 may also be changed due to a change in which service providers are used by the online store 138 (e.g., which third-party apps are installed for the online store 138). A change to the data sharing settings 340 may be a change to the type of user data collected, a change to how long user data is stored, a change to how user data is shared, or a change to the third parties sharing the user data (e.g., a change to data sharing with third party apps currently installed for the online store 138 and/or a change to which third party apps are installed for the online store 138), among other possibilities.

Optionally, in some examples, if the change to the data sharing settings 340 is determined to be a decrease in data collection (e.g., the settings of the online store 138 has changed to collect fewer types of user data, or smaller amount of user data overall, or both), a decrease in storing of user data (e.g., the settings of the online store 138 has changed to store some or all types of user data for a shorter time duration), or a decrease in sharing of user data (e.g., the settings of the online store 138 has changed to share user data with fewer third-parties, or to share fewer types of user data, or both), the privacy management engine 350 may determine that such a change does not need to be notified to the user. For example, it may be assumed that a user would not find a decrease in data collection and sharing to be objectionable, and a notification of such a change would be of no benefit (or may be an inconvenience) to the user. In such a case, the method 800 may end.

Optionally, at 812, the privacy management engine 350 may determine, using the predefined settings 324 defined in the user profile 322, whether the change in data sharing settings (determined at 806) has been indicated as being acceptable to the user. For example, the predefined settings 324 may indicate that data sharing (of a specific type of user data or of any user data) with a specific service provider is acceptable, that collection and sharing of data (a specific type of user data or any user data) by a specific online store (or merchant, or merchant account) is acceptable, or that any collection and sharing of a specific type of user data is acceptable.

If the determined change in data sharing settings falls within the set of acceptable settings indicated in the predefined settings 324, it may not be necessary to notify the user of the change. The method 800 may end. Alternatively, even if the change in data sharing settings is within the set of acceptable settings indicated in the predefined settings 324, the change may nonetheless be notified to the user, to provide the user with an opportunity to revoke or modify their acceptance.

Optionally, in some examples, the predefined settings 324 may include indicated unacceptable settings. For example, the predefined settings 324 may indicate that data sharing (of a specific type of user data or of any user data) is unacceptable for a specific service provider, that collection and sharing of data (a specific type of user data or any user data) by a specific online store is unacceptable, or that any collection and sharing of a specific type of user data is unacceptable. If the determined change in data sharing settings is within the set of unacceptable settings indicated in the predefined settings 324, current and/or further events (e.g., current/further page view, current/further product search, current/further step in a transaction, completion of an online purchase, etc.) at the online store 138 may be automatically blocked for the user. If a current/further event is blocked due to predefined settings 324, optionally a notification may be generated to notify the user of the reason for the blocking and/or optionally the notification may provide the user an option to permit the current/further event (for one time only, or for more than one time) despite the predefined settings 324.

If the determined change in data sharing settings is not within the acceptable settings (and also is not within the unacceptable settings) indicated in the predefined settings 324, the method 800 proceeds to step 814 to notify the user of the change.

At 814, the privacy management engine 350 generates and transmits to the user device 150 a notification indicating the change that was determined at 806. The notification may be formatted in order to present the determined change in a way that is relatively easy to understand. For example, the notification may be presented as an infographic (e.g., tabular format) that clearly indicates the change to data sharing settings 340 at the online store 138 (e.g., the type of user data affected and/or the service provider involved). Additionally, the notification may include a link to further information, such as a link to the relevant clause in the online store's privacy policy 346 and/or a link to the privacy policy of the relevant service provider.

Optionally, the notification may include an option to accept and/or an option to reject the determined change. The option may further include information about how accepting or rejecting the change may affect events at the online store 138 (e.g., may permit or block certain events from taking place at the online store, such as may permit or block the user from completing an online purchase). If the option to accept the change is selected, the notification may be dismissed and the user may continue interacting with the online store 138. The timestamp associated with the current event may be recorded, for example as a timestamped event 326 in the user profile 322 associated with the user and/or a cookie (or other tracking data) associated with the user. Recording the timestamp enables the e-commerce platform 100 to determine (e.g., at a future user event at the online store 138) that the user has accepted the data sharing settings 340 as of the time of the current event.

Optionally, at 816, if the user selects an option that indicates the change is rejected (e.g., the option to reject the change is selected, or the generated notification is dismissed without selection of the option to accept the change), the current and/or further event may be blocked at the online store 138. For example, a current/further page view may be blocked, a current/further product search may be blocked, or a current/further step in a transaction (e.g., an online purchase) may be blocked. The method 800 may end.

In some examples, instead of providing an option to reject the data sharing (which may automatically block the user from the current/further event), the notification may instead provide information to enable the user to reject data sharing at a future time (e.g., after completing the current/further event) and/or on a different platform (e.g., at the relevant third-party service provider). For example, if the notification informs the user that collected user data will be shared with Service Provider A, the user may be provided with information and/or a redirection link to change the user's own settings at Service Provider A. Such an option may enable the user to complete the current/further event at the online store 138, but may still prevent Service Provider A from access to the user's data.

Optionally, at 818, if the option to accept the change is selected and a user profile 322 is associated with the user, the user profile 322 may be updated to reflect the accepted change. For example, the predefined settings 324 in the user profile 322 may be automatically updated to indicate the change is an acceptable setting. The predefined settings 324 may be updated to indicate that the change is an acceptable setting only for this online store 138. Alternatively, the predefined settings 324 may be updated to indicate that the change is an acceptable setting across multiple online stores. For example, the notification may provide an option to accept the change in data sharing only for this online store 138, and may also provide an option to accept the change in data sharing across multiple online stores. It may be convenient to provide the user with an option to accept the change across multiple online stores, for example in the case where the change in data sharing is related to a service provider (e.g., a third-party social media service provider) that is commonly used by many online stores.

The user may then continue interacting with the online store 138 and the method 800 may end.

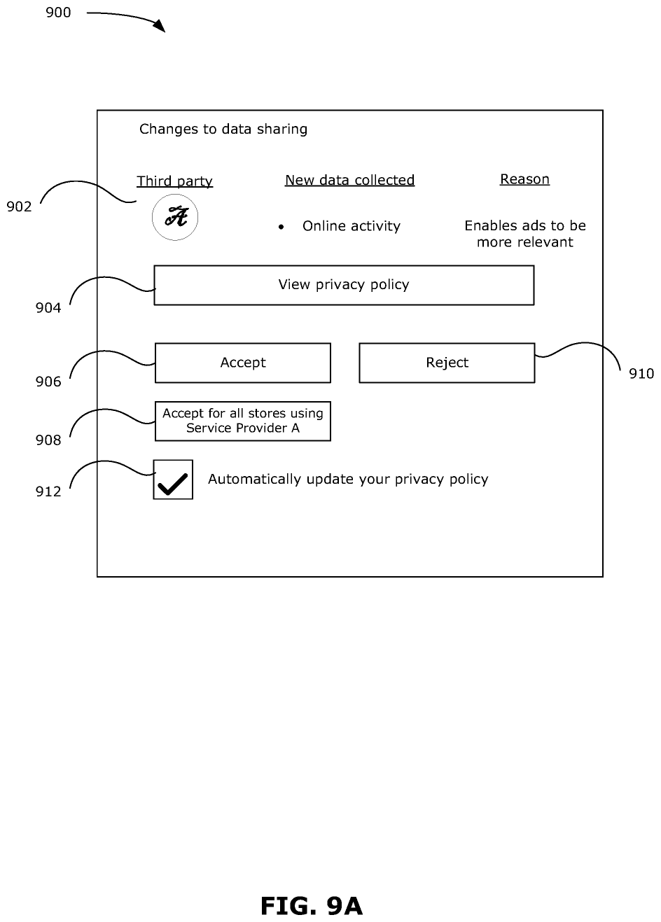

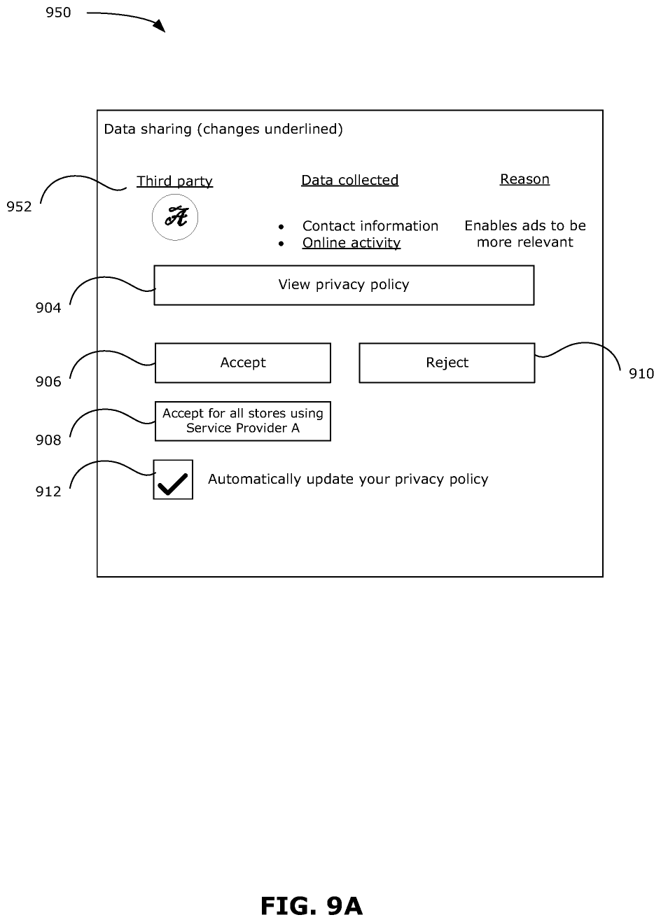

FIG. 9A illustrates an example notification 900 that may be generated in accordance with the method 800. The notification 900 may be generated by the privacy management engine 350 to be presented on a user device 150, for example (e.g., at step 814 of FIG. 8).

The notification 900 in this example has been generated after determining a change in data sharing settings 340 at an online store 138, where the change has been determined as being related to data sharing with the third-party service provider “Service Provider A”. In particular, the notification 900 includes information that explicitly shows the specific change in data sharing settings 340 (e.g., the specific change in type of user data collected and/or shared, and/or the service provider that the data is being shared with) since a previous event (e.g., previous visit) when previous data sharing settings were accepted, rather than requiring the user to discern the change themselves.

The example notification 900 provides information in the form of an infographic table 902, which indicates the new user data being collected/shared (“online activity”), the service provider (indicated by the logo of Service Provider A) that the data is being shared with, and optionally a reason for sharing the data (“enables ads to be more relevant”). The information for populating the table 902 may be extracted from the settings log 342 and data sharing settings 340 of the online store 138, as discussed above. The notification 900 includes a link 904 to view the privacy policy 346 of the online store 138. The link 904 may automatically link to the specific clause in the privacy policy 346 that is relevant to the notified change. Additionally or alternatively, the notification 900 may include another link (not shown) to view the privacy policy of Service Provider A.

In this example, the notification 900 also includes a selectable option to accept the indicated change 906, a selectable option to accept the indicated change for all stores using the indicated service provider 908, and a selectable option to reject the indicated change 910. Further, the notification 900 includes a selectable option 912 to enable or disable automatic updating of the predefined settings 324 of the user profile 322 associated with the user. The option 912 may not be presented or may be greyed out if there is no user profile 322 associated with the user. If the option 910 is selected, step 816 of FIG. 8 may be performed. If the option 906 or 908 is selected and the option 912 is also selected, step 818 of FIG. 8 may be performed.

FIG. 9B illustrates another example notification 950 that may be generated in accordance with the method 800. The notification 950 may be generated by the privacy management engine 350 to be presented on a user device 150, for example (e.g., at step 814 of FIG. 8). The notification 950 is similar to the notification 900 of FIG. 9A. However, in the notification 950 of FIG. 9B, the infographic table 952 displays all user data used by Service Provider A, with an indication (in this example, underline) to show the new type of user data being used. Further, although not shown in FIG. 9B, the table 952 may include information about user data used by other service providers (even those without changes to user data collection and sharing). The notification 950 may provide to the user more fulsome information about all the ways the user's data is being used by different service providers, while at the same time highlighting the new changes to data sharing.

In the above discussion, a timestamp of an earlier event associated with the user at the online store 138 may be tracked using a cookie (or other tag associated with the user, which may be stored at the user device 150). If the cookie (or other tag) is deleted from the user device 150, the user is not associated with a user profile 322, and the user is not otherwise identifiable, then the user may be presented with the full privacy policy 346 associated with the online store 138. In other words, the user in such a case may be treated as if the user had never interacted with the online store 138 previously.

As illustrated in the examples discussed above, the disclosed methods and systems enable a user to be explicitly informed as to whether and how an online store's data sharing settings have changed since an earlier user event at that online store. In particular, the user's preferences for data sharing may be defined across multiple online stores (e.g., as indicated in predefined settings 342 in the user profile 322 associated with the user). For example, a user may only need to be notified once, at an event at a given online store, of a change in data sharing by a given service provider, and acceptance of that change at the given online store may automatically result in acceptance across all online stores using the given service provider. Thus, the user experience may be more convenient, with fewer interruptions to the user's online experience. Further, there may be more efficient data sharing by online stores and/or reduced exchange of communication between user device and online services.

As mentioned previously, in some examples, the privacy management engine 350 may enable an online store's privacy policy 346 to be automatically updated, in response to changes to the data sharing settings 340. A change to the data sharing settings 340 may be due to a merchant (or other administrator of the online store 138) manually changing store configuration settings (e.g., using a UI as described above), may be due to changes in the usage of user data by applications already installed for the online store 138, and/or may be due to changes to which applications have been installed for the online store 138.

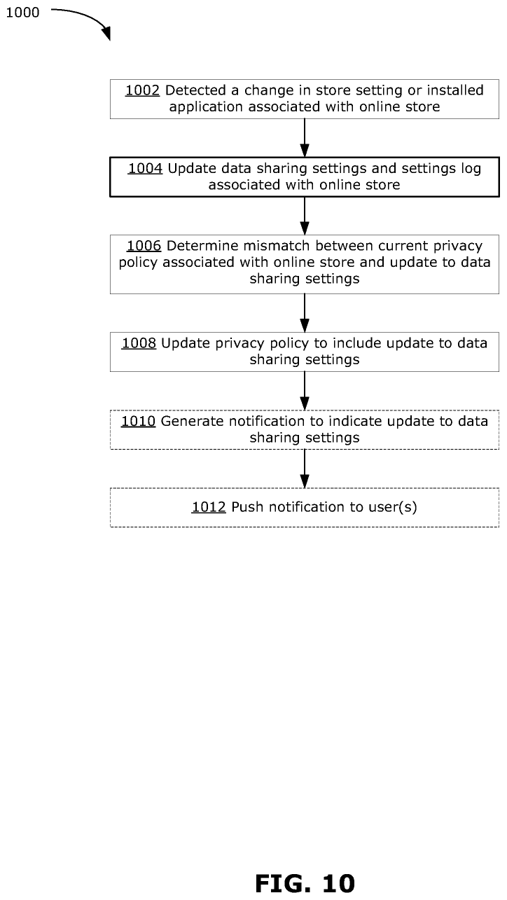

FIG. 10 is a flowchart illustrating an example method 1000 for automatically updating a privacy policy associated with an online store. The method 1000 may be implemented by the e-commerce platform 100 (e.g., using the privacy management engine 350). The method 1000 may be implemented by a processing device executing instructions (e.g., at the core server 510 or the applications server 530).

At 1002, a change in data sharing settings associated with the online store 138 is detected. For example, a change in data sharing settings 340 may be caused by a merchant manually changing store configuration settings (e.g., using a UI as described above). This change in store configuration settings may be communicated to the privacy management engine 350.

A change in data sharing settings may also be caused by a change in which applications (e.g., third-party applications provided by third-party service provider 160 and/or first-party applications provided by the e-commerce platform 100) have been installed for the online store 138. For example, any installation or uninstallation of applications on the online store 138 may be automatically communicated to the privacy management engine 350. The privacy management engine 350 may then query the third-party service provider 160 (if the relevant application is a third-party application) or access information stored on the e-commerce platform 100 (if the relevant application is a first-party application) to determine how data sharing settings 340 at the online store 138 are affected. A change in data sharing settings may also be caused by a change in how previously-installed applications use user data from the online store 138. For example, a third-party service provider 160 may be obligated to inform the online store 138 of any changes to usage of user data by the third-party application installed on the online store 138.

At 1004, the privacy management engine 350 updates the data sharing settings 340 and the settings log 342 to clearly indicate changes in the data sharing by installed applications. For example, each selectable data sharing setting provided in a UI may be associated with a set of predefined data sharing settings. Accordingly, a change in the UI settings corresponds to a change in the data sharing settings 340 associated with the online store 138. In the case where the change is a change in installed applications associated with the online store 138, the privacy management engine 350 may use information provided by a third-party service provider 160 or by the e-commerce platform 100 to update the data sharing settings 340 and the settings log 342.

At 1006, the privacy management engine 350 determines if there is any mismatch between the current privacy policy 346 associated with the online store 138 and the updated data sharing settings 340. For example, each clause in the privacy policy 346 may be associated with particular data sharing setting (e.g., defining a type of user data, defining how the user data is collected, defining how the user data is stored and/or defining how the user data is shared). A mismatch may be found if there is any data sharing setting that is not included in the privacy policy 346. A mismatch may also be found if there is any clause in the privacy policy 346 that does not correspond to the data sharing settings 340.

At 1008, the privacy policy 346 is updated to match the updated data sharing settings 340. For example, the privacy management engine 350 may access information (e.g., textual clauses, and/or infographics) stored in the privacy updates database 355. The privacy updates database 355 may store textual data and/or infographic data that may be independently retrieved and used to populate the privacy policy 346 (e.g., depending on whether the privacy policy 346 is a textual document, an infographic representation, or both). For example, the privacy updates database 355 may store a table or other data structure in which privacy clauses and/or infographic table entries may be looked up (e.g., indexed) in order to retrieve the necessary textual data and/or infographic data for updating the privacy policy 346. The updated privacy policy 346 may be stored for the online store 138, for example in order to be presented to a user at an event (e.g., a page view or a product search event) at the online store 138.

Optionally, at 1010, the privacy management engine 350 may generate a notification to indicate the updated data sharing settings. The notification may be provided to inform the merchant about how merchant-selected changes to store configuration settings (e.g., using a UI) or installation of an application affects user data collection and sharing at the online store 138. The notification may provide an option for the merchant to confirm or reject the updated data sharing settings. In some examples, if the updated data sharing settings are rejected, then the action that caused the change in data sharing settings (e.g., installation of an application or manual change to store configuration settings) may be automatically undone (e.g., automatic uninstallation of the application or automatic reversion to the previous store configuration settings).

Optionally, at 1012, the privacy management engine 350 may push a notification to one or more users (e.g., customers of the online store 138 who have subscribed to communications from the online store 138) to indicate the updated data sharing settings. The notification that is pushed to user(s) may be different from the notification that is provided to the merchant. The notification that is pushed to user(s) may be similar to the notification that is provided to the merchant, but may have different selectable options. For example, the notification that is pushed to user(s) may include a link to view the entire privacy policy 346 associated with the online store, may include an option to accept the updated data sharing settings for this online store 138 or may include an option to automatically update the user's user profile 322 to include the updated data sharing settings as acceptable settings (e.g., acceptable across multiple online stores, or acceptable only for this online store) indicated by the predefined settings 324. If the user accepts the updated data sharing settings, a timestamp of the updated data sharing settings may be recorded (e.g., stored in timestamped events 326 in the user's user profile 322, or stored using a cookie associated with the user). Thus, when the user visits the online store 138 in the future, it will be recognized that the user has already accepted the updated data sharing settings.

The method 1000 may help to ensure that the privacy policy 346 for an online store 138 is updated in an accurate and timely way, without requiring the merchant to manually select clauses to be included in the privacy policy 346. Further, in some examples the method 1000 may provide a notification to inform a merchant how a merchant action impacts the data sharing settings 340, which may be useful in situations where impact on data sharing may not be readily apparent (e.g., a merchant may not fully appreciate or understand how installation of an application will impact the collection and sharing of user data at the online store 138). In some examples, the method 1000 may automatically push a notification to inform user(s) of updates to data sharing settings 340 at the online store 138. The push notification may enable a user to review and accept the updated data sharing settings 340 prior to a user interaction at the online store 138, such that when the user does interact with the online store 138 at a later time, the user experiences fewer interruptions.

The push notification that is generated and communicated to a user may be similar to the notifications 900, 950 of FIGS. 9A and 9B, described above. The push notification may be communicated to a user in an email communication, for example.

In examples discussed herein, timestamps are described as an example technique for tracking changes to the data sharing settings of an online store. It should be understood that other suitable techniques may be used. For example, instead of timestamps, version numbers associated with different versions of the privacy policy may be used. Another approach may be to rely on the predefined settings in the user profile to notify the user of data sharing settings that have not been previously accepted (e.g., based on the assumption that previously accepted data sharing settings are automatically indicated as acceptable in the predefined settings).

The principles described herein address a number of problems present in conventional on-line stores systems. For example, it can be difficult for a user visiting an online store to fully understand a store's privacy policy andr determine whether or to what extent data settings used by the store apply to their specific situation. In addition, if an online store's data sharing settings have changed since a user's previous visit, it is a difficult if not impossible task for the user to discern whether there has been a change to the settings based on the displayed privacy policy. Even if the user is aware that the privacy policy has changed, it can be difficult to discern what the change entails or whether the change is significant to the user's specific situation. When a user interacts with multiple online stores, the burden of repeatedly checking privacy policies accumulates.

In various examples, the present disclosure describes methods and systems that may provide a more user-friendly experience. A user interacting with an online store may be provided with easy to understand information about changes to data sharing at the online store. The user may also be provided the ability to automatically accept certain levels of data sharing across multiple online stores. A user may not need to be notified again if a given data sharing setting at one online store was previously accepted at another online store.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

All referenced documents are hereby incorporated by reference in their entireties.

1. A system comprising:
a processing device in communication with a storage, the processing device configured to execute instructions to cause the system to:
in response to a current event associated with a user at an online store, determine a first timestamp associated with a previous event associated with the user at the online store;
determine at least one change to a set of data sharing settings associated with the online store, the at least one change being associated with a second timestamp indicating a time between the first timestamp and the current event; and
transmit a notification to a device associated with the user indicating the at least one change.

2. The system of claim 1, wherein the at least one change is one or more of: a change to type of user data collected, a change to how collected data is shared, a change to how long collected data is stored, a change to which service provider is sharing collected data, or a change to how a service provider is sharing collected data.

3. The system of claim 2, wherein the at least one change is a result of: an installation of an application associated with the online store, an uninstallation of an application associated with the online store, a change in data sharing with an installed application associated with the online store, or a change in configuration settings associated with the online store.

4. The system of claim 1, wherein the processing device is configured to execute instructions to further cause the system to:
determine, from a stored privacy profile associated with the user, whether the at least one change is indicated as acceptable within a set of predefined settings in the privacy profile; and
wherein the notification is transmitted after determining that the at least one change is excluded from the set of predefined settings.

5. The system of claim 4, wherein the processing device is configured to execute instructions to further cause the system to:
transmit the notification, including a selectable option to accept the at least one change; and
after receiving input indicating the at least one change is accepted, update the privacy profile associated with the user to include the at least one change in the set of predefined settings.

6. The system of claim 5, wherein the privacy profile is updated to include the at least one change in the set of predefined settings in association with the online store.

7. The system of claim 5, wherein the privacy profile is updated to include the at least one change in the set of predefined settings in association with a plurality of online stores.

8. The system of claim 1, wherein the processing device is configured to execute instructions to further cause the system to:
in response to an update to a privacy policy associated with the online store, determine at least a second change to the set of data sharing settings associated with the online store;
transmit a second notification to the device associated with the user indicating at least the second change; and
update the first timestamp to reflect a time associated with the updated to the privacy policy.

9. The system of claim 1, wherein the notification is transmitted when the at least one change is an increase in data collection or an increase in data sharing.

10. The system of claim 1, wherein the processing device is configured to execute instructions to further cause the system to:
transmit the notification, including a selectable option to reject the at least one change; and
block the current event or a further event at the online store after receiving input indicating the at least one change is rejected.

11. A method comprising:
in response to a current event associated with a user at an online store, determining a first timestamp associated with a previous event associated with the user at the online store;
determining at least one change to a set of data sharing settings associated with the online store, the at least one change being associated with a second timestamp indicating a time between the first timestamp and the current event; and
transmitting a notification to a device associated with the user indicating the at least one change.

12. The method of claim 11, wherein the at least one change is one or more of: a change to type of user data collected, a change to how collected data is shared, a change to how long collected data is stored, a change to which service provider is sharing collected data, or a change to how a service provider is sharing collected data.

13. The method of claim 12, wherein the at least one change is a result of: an installation of an application associated with the online store, an uninstallation of an application associated with the online store, a change in data sharing with an installed application associated with the online store, or a change in configuration settings associated with the online store.

14. The method of claim 11, further comprising:
determining, from a stored privacy profile associated with the user, whether the at least one change is indicated as acceptable within a set of predefined settings in the privacy profile; and
wherein the notification is transmitted after determining that the at least one change is excluded from the set of predefined settings.

15. The method of claim 14, further comprising:
transmitting the notification, including a selectable option to accept the at least one change; and
after receiving input indicating the at least one change is accepted, updating the privacy profile associated with the user to include the at least one change in the set of predefined settings.

16. The method of claim 15, wherein the privacy profile is updated to include the at least one change in the set of predefined settings in association with the online store.

17. The method of claim 15, wherein the privacy profile is updated to include the at least one change in the set of predefined settings in association with a plurality of online stores.

18. The method of claim 11, further comprising:
in response to an update to a privacy policy associated with the online store, determining at least a second change to the set of data sharing settings associated with the online store;
transmitting a second notification to the device associated with the user indicating at least the second change; and
updating the first timestamp to reflect a time associated with the updated to the privacy policy.

19. The method of claim 11, further comprising:
transmitting the notification, including a selectable option to reject the at least one change; and
blocking the current event or a further event at the online store after receiving input indicating the at least one change is rejected.

20. A computer readable medium having computer-executable instructions stored thereon, wherein the instructions, when executed by a processing device of a system, cause the system to:
in response to a current event associated with a user at an online store, determine a first timestamp associated with a previous event associated with the user at the online store;
determine at least one change to a set of data sharing settings associated with the online store, the at least one change being associated with a second timestamp indicating a time between the first timestamp and the current event; and
transmit a notification to a device associated with the user indicating the at least one change.
